(19) United States
(12) Patent Application Publication
(10) Pub. No.: US 2024/0273199 A1
(43) Pub. Date: Aug. 15, 2024

(54) INFORMATION PROCESSING APPARATUS AND CONTROL METHOD THEREOF

(71) Applicant: SHARP KABUSHIKI KAISHA, Osaka (JP)

(72) Inventor: MASAKI INUI, Osaka (JP)

(21) Appl. No.: 18/435,254

(22) Filed: Feb. 7, 2024

(30) Foreign Application Priority Data
Feb. 13, 2023 (JP) 2023-019598

(51) Int. Cl. G06F 21/56

(52) U.S. Cl. CPC G06F 21/561; G06F 2221/034

(57) ABSTRACT

An information processing apparatus includes a controller that, upon reception of job information accompanied by authentication information capable of specifying a user, determines whether the job information is infected with a virus or not, wherein the controller: causes use restriction information capable of specifying restriction of use by the user in association with the authentication information to be stored in a storage, when it is determined that the job information is infected with the virus; and restricts use of the information processing apparatus by the user specified by the authentication information associated with the use restriction information, when the use restriction information is stored in the storage.

### CROSS-REFERENCE TO RELATED APPLICATION

The present application claims priority from Japanese Patent Application NO. JP2023-019598 filed on Feb. 13, 2023, the content to which is hereby incorporated by reference into this application.

### BACKGROUND OF THE INVENTION

### Field of the Invention

The present disclosure relates to an information processing apparatus and a control method thereof.

### Description of the Related Art

In recent years, a multifunction peripheral as an example of an information processing apparatus has been developed. Such an information processing apparatus has a function of detecting whether received job information is infected with a virus or not.

### SUMMARY OF THE INVENTION

Even when the information processing apparatus detects a virus, if a user continuously uses the information processing apparatus without noticing that the user is processing job information infected with the virus, it is expected that the information processing apparatus receives the job information infected with the virus again from the user.

The present disclosure has been made in view of the above problems. An object of the present disclosure is to provide an information processing apparatus capable of suppressing repeated reception of job information infected with a virus from the same user, and a control method thereof.

An information processing apparatus according to this disclosure is an information processing apparatus including a controller which, upon reception of job information accompanied by authentication information capable of specifying a user, determines whether the job information is infected with a virus or not, in which the controller stores use restriction information capable of specifying restriction of use by the user in association with the authentication information in a storage, when it is determined that the job information is infected with the virus, and when the use restriction information is stored in the storage, restricts use of the information processing apparatus by the user specified by the authentication information associated with the use restriction information.

A control method of an information processing apparatus according to this disclosure is a control method of an information processing apparatus including a controller which, upon reception of job information accompanied by authentication information capable of specifying a user, determines whether the job information is infected with a virus or not, in which the controller executes a step, when the job information is determined to be infected with the virus, of causing use restriction information capable of specifying restriction of use by the user in association with the authentication information to be stored in a storage, and a step of restricting use of the information processing apparatus by the user specified by the authentication information associated with the use restriction information when the use restriction information is stored in the storage.

### BRIEF DESCRIPTION OF THE DRAWINGS

FIG. 1 is a functional block diagram in a case where an information processing apparatus according to an Embodiment imposes a use restriction;

FIG. 2 is a diagram illustrating a data table stored in a storage of an information processing apparatus according to a variation of the Embodiment;

FIG. 3 is a functional block diagram illustrating a first example of a method by which the information processing apparatus according to the Embodiment releases the use restriction;

FIG. 4 is a functional block diagram illustrating a second example of the method by which the information processing apparatus according to the Embodiment releases the use restriction;

FIG. 5 is a functional block diagram illustrating a third example of the method by which the information processing apparatus according to the Embodiment releases the use restriction;

FIG. 6 is a flowchart for explaining a first example of a method of executing use restriction by the information processing apparatus according to the Embodiment;

FIG. 7 is a flowchart for explaining a second example of the method of executing use restriction by the information processing apparatus according to the Embodiment;

FIG. 8 is a flowchart for explaining the first example of the method of releasing the use restriction by the information processing apparatus according to the Embodiment;

FIG. 9 is a flowchart for explaining the second example of releasing the use restriction by the information processing apparatus according to the Embodiment; and

FIG. 10 is a flowchart for explaining the third example of releasing the use restriction by the information processing apparatus according to the Embodiment.

### DETAILED DESCRIPTION OF THE INVENTION

Embodiments of an information processing apparatus of this disclosure will be explained below with reference to drawings. It is to be noted that, in the drawings, the same or equivalent elements are denoted by the same reference numerals, and the duplicate description will not be repeated.

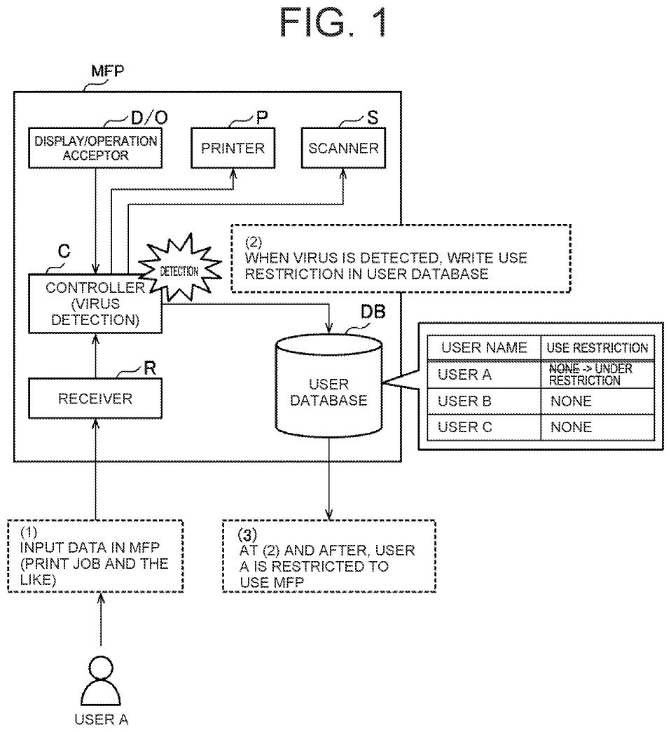

An information processing apparatus MFP according to an Embodiment will be explained by using FIGS. 1 to 10.

FIG. 1 is a functional block diagram in a case where an information processing apparatus MFP according to this Embodiment imposes a use restriction. FIG. 1 illustrates a mechanism for restricting the use of the information processing apparatus MFP for a user A in association with authentication information of the user A, when a virus is detected due to an operation of the information processing apparatus MFP by the user A.

The information processing apparatus MFP according to this Embodiment is a multifunction peripheral. The multifunction peripheral has a plurality of functions corresponding to a plurality of devices such as a print function, a scanner function, a copy function, and a FAX function. However, the information processing apparatus MFP may be an individual apparatus having an individual function such as the print function, the scanner function, the copy function, or the FAX function. Further, the information processing apparatus MFP may be an apparatus having a function different from the plurality of functions of the multifunction peripheral, such as a personal computer or a communication terminal.

As shown in FIG. 1, the information processing apparatus MFP of this Embodiment includes a receiver R, a controller C, a display/operation acceptor D/O, a printer P, a scanner S, and a storage (database) DB.

The receiver R is a port that receives data from an outside. The receiver R receives job information, for example, print job information from, for example, a network interface, a universal serial bus (USB) memory of the user A, or a jack of a cable, and transmits the job information to the controller C. However, the receiver R may be an antenna for wireless communication or the like.

The storage DB is a memory called a user database capable of storing a user name and information for use restriction in association with each other. The storage DB is configured to be rewritable. The storage DB may be any storage as long as it can store electronic information. The storage DB may be a data server provided outside the information processing apparatus MFP. When the storage DB is provided outside the information processing apparatus MFP, the information processing apparatus MFP and the storage DB transmit and receive information to and from each other through wireless communication or wired communication. It is to be noted that, when the storage DB is a data server provided outside the information processing apparatus MFP, a plurality of information processing apparatuses MFP refer to a common storage DB.

The display/operation acceptor D/O includes, for example, a touch panel in which an operation acceptor and a display are integrated, in addition to a push-button type operation acceptor. In this Embodiment, the display/operation acceptor D/O is formed integrally with other parts such as the controller C. However, the device display/operation acceptor D/O may be the one separated from the information processing apparatus MFP such as a remote controller. In this case, the display/operation acceptor D/O and the controller C communicate with each other in a wireless or wired manner.

The controller C is a computer called a processor. The controller C controls each of the printer P and the scanner S on the basis of a program stored in a memory incorporated in itself and a command signal received from the display/operation acceptor D/O.

The controller C according to this Embodiment has a virus detection function of detecting whether the job information received from the external apparatus via the receiver R is infected with a virus or not on the basis of the aforementioned program. That is, the controller C determines whether or not the job information is infected with a virus in a case where the job information to which the authentication information capable of specifying the user is attached is received.

When it is determined that the job information is infected with a virus, the controller C stores use restriction information capable of specifying that the use by the user A is restricted in the storage DB as a database in association with the authentication information. For example, in FIG. 1, restriction of the use of the information processing apparatus MFP by the user A is stored in the storage DB. In this case, when the use restriction information is stored in the storage DB, the controller C restricts the use of the information processing apparatus MFP by the user A specified by the authentication information associated with the use restriction information.

Specifically, the information processing apparatus MFP executes processing as follows.

(1) A user A inputs job information such as a print job, which is an example of data, to the information processing apparatus MFP. (2) As a result, when the virus is detected, that is, when it is determined that the job information is infected with the virus, the controller C writes information capable of specifying that the use by the user A is restricted in the storage DB as the user database. As a result, (3) the use of the information processing apparatus MFP by the user A is restricted.

Thereafter, the user A operates an external communication terminal to input the authentication information from the communication terminal via the receiver R, whereby the authentication information is added to the job information. Subsequently, the authentication information of the user A himself/herself or the job information to which the user name of the user A is attached, for example, is transmitted to the controller C. However, the authentication information may be information other than the user name, that is, it may be information such as a mail address of the user, a user authentication number, a face image of the user, a fingerprint image of the user, or a voiceprint of the user.

In this case, the controller C determines whether the authentication information that matches the authentication information of the user A attached to the job information is stored in the storage DB or not. As a result, as shown in FIG. 1, when the authentication information of the user A is stored in the storage DB, the controller C determines whether or not the storage DB stores information indicating that the use by the user A is restricted.

As a result, when it is stored in the storage DB that the use by the user A is restricted, the controller C restricts the use of the information processing apparatus MFP by the user A. That is, even when the user A operates the display/operation acceptor D/O, the controller C sets a state in which the printer P and the scanner S do not perform any function.

Specifically, the controller C causes data “under restriction”, to be stored in a column of the user A in the storage DB so that the user A cannot use any of the print function, the copy function, the scanning function, and the FAX function of the information processing apparatus MFP. It is to be noted that, in FIG. 1, the use of the information processing apparatus MFP by a user B and a user C or the like other than the user A stored in the storage DB is not restricted.

According to the information processing apparatus MFP of this embodiment as described above, it is possible to restrict subsequent use of the information processing apparatus MFP by the user A, who has transmitted the job information detected to be infected with the virus to the information processing apparatus MFP. Therefore, it is possible to suppress repeated reception of the job information infected with a virus from the same user A. It is to be noted that, when the storage DB is a data server provided outside the information processing apparatus MFP, use by the same user A can be restricted in any of the plurality of information processing apparatuses MFP.

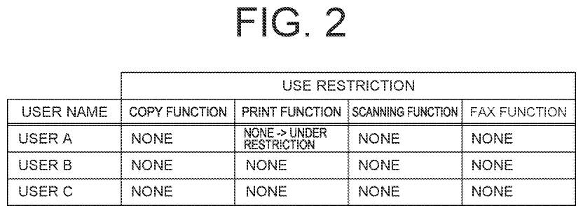

FIG. 2 is a diagram illustrating a data table stored in the storage DB as a database of an information processing apparatus according to a variation of the Embodiment. FIG. 2 is a diagram for explaining that the information processing apparatus MFP can set use restriction for each of a plurality of functions.

The information processing apparatus MFP of this Embodiment is a multifunction peripheral that exerts a plurality of functions corresponding to a plurality of apparatuses as described above. However, in FIG. 2, the controller C individually stores the use restriction information in the storage DB for each of the plurality of functions.

As a result, the controller C individually restricts the use of the information processing apparatus MFP by the user for each of the plurality of functions. For example, as shown in FIG. 2, the use of only the print function by the user A is restricted by storing the data “restricted” in the column of the print function of the user A in the storage DB.

For example, when a virus is included in the print job information for using the print function, restriction on the use of only the print function by the user A is considered. That is, it can be considered to restrict the use by the user A of the same function as the function intended to be used by the job information infected with the virus.

According to the information processing apparatus MFP of this Embodiment as above, the use of the information processing apparatus MFP by each user can be individually restricted for each of the plurality of functions. Therefore, even a user who transmitted job information infected with a virus in a specific function to the information processing apparatus MFP can use a function other than the print function of the information processing apparatus MFP. Therefore, it is possible to suppress excessive imposition of use restriction of the information processing apparatus MFP on the user A. It is to be noted that, in the case where the storage DB is a data server provided outside the information processing apparatus MFP, any of the plurality of information processing apparatuses MFP can restrict the use of the print function by the same user A and use a function other than the print function.

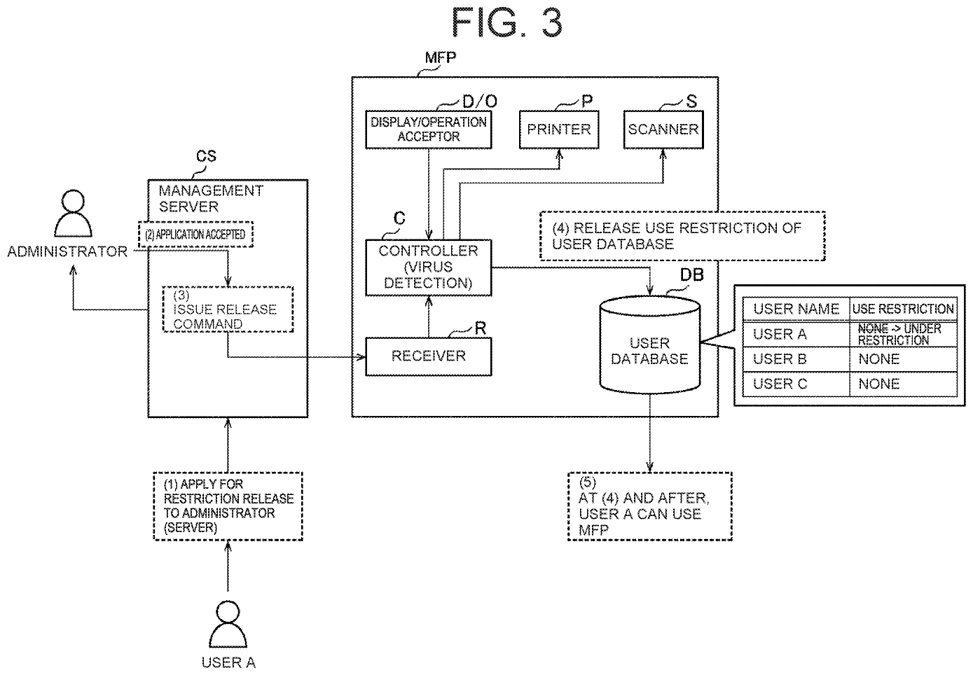

FIG. 3 is a functional block diagram illustrating a first example of a method by which the information processing apparatus MFP according to the Embodiment releases the use restriction. More specifically, FIG. 3 is a diagram illustrating a mechanism in which the use restriction is released when the user, who is a target of the use restriction, receives use permission from an administrator.

The controller C of this Embodiment invalidates use restriction information in the storage DB upon reception of restriction release information capable of specifying release of the use restriction of the information processing apparatus MFP by the user A. The invalidation of the use restriction information may be any of deletion of the use restriction information from the storage DB, addition of the use-restriction release information to the use restriction information stored in the storage DB, or the like. For example, as shown in FIG. 3, the use restriction information is invalidated by rewriting data “under restriction” to data “none” in the column of the user A of the storage DB.

As a result, the restriction on the use of the information processing apparatus MFP by the user A specified by the authentication information stored in the storage DB can be released. According to the information processing apparatus MFP of this Embodiment as described above, it is possible to allow the user A to re-use the information processing apparatus MFP by releasing the use restriction of the information processing apparatus MFP.

In this case, the controller C receives the restriction release information from the management server CS on the basis of a predetermined operation on an operation acceptor of the management server CS that manages the information processing apparatus MFP. According to the above, the controller C of the information processing apparatus MFP can release the restriction of use by the user A on the basis of the restriction release information received from the management server CS.

Specifically, (1) the user A applies for permission to re-use the information processing apparatus MFP to the administrator of the information processing apparatus MFP by transmitting, to a management server CS, information indicating that learning using a learning content was finished. (2) When the administrator of the information processing apparatus MFP accepts the application for permission to re-use the information processing apparatus MFP by the user A, the administrator determines whether or not the learning by the learning content was appropriately finished.

As a result, when the administrator determines that the user A appropriately finished the learning by the learning content, the administrator accepts (permits) re-use of the information processing apparatus MFP by the user A. In this case, the administrator inputs information for releasing the use restriction of the user A to the management server CS by operating the operation acceptor of the information processing apparatus MFP. (3) As a result, the management server CS transmits restriction release information (release command) to the information processing apparatus MFP.

(4) When the controller C of the information processing apparatus MFP receives the restriction release information (release command) from the management server CS via the receiver R, the controller C rewrites the data “under restriction” of the user A stored in the storage DB to “none”. As a result, the controller C invalidates, that is, releases the use restriction of the information processing apparatus MFP for the user A. (5) As a result, the user A can use the information processing apparatus MFP again. Specifically, the controller C allows the user A to use the print function, the copy function, the scanning function, and the FAX function by the printer P of the information processing apparatus MFP.

As described above, the restriction release information is learning completed information that can identify that the user A has learned about viral infection prevention using the learning content. That is, after the user A is allowed to learn about prevention of virus infection, the use restriction information is invalidated in the storage DB. Therefore, it is possible to suppress with a considerably high probability that the information processing apparatus MFP repeatedly receives the job information infected with a virus from the same user A.

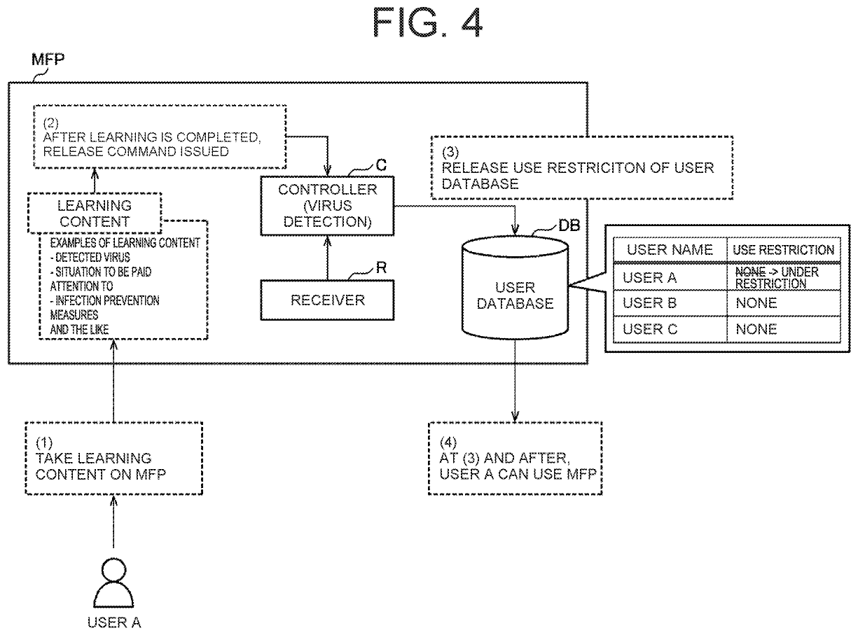

FIG. 4 is a functional block diagram illustrating a second example of the method by which the information processing apparatus MFP according to the Embodiment releases the use restriction. FIG. 4 is a diagram illustrating a mechanism in which the user A, who is the target of the use restriction, performs the learning by the learning content by using the information processing apparatus MFP so that the use restriction is released.

In this case, the controller C causes the display/operation acceptor D/O to display the learning content. An example of the learning content is information such as a detected virus, a situation to be paid attention to, and an infection prevention measure.

As a result, when a predetermined operation was performed on the display/operation acceptor D/O, the controller C regards that the learning of virus infection prevention by the learning content was appropriately finished and releases the use restriction of the information processing apparatus MFP. That is, the user A can release the restriction on the use of the information processing apparatus MFP by operating the display/operation acceptor D/O by the user A himself/herself.

Specifically, (1) the user A views the image of the learning content displayed on the display/operation acceptor D/O of the information processing apparatus MFP, thereby finishing the learning by the learning content. In this learning, an answer to a learning-effect confirmation test is transmitted by operating the display/operation acceptor D/O. (2) As a result, when the learning-effect confirmation test is passed, the controller C transmits the restriction release information (release command) to the storage DB.

(3) As a result, the storage DB that received the release command rewrites the data “under restriction” to “none”, thereby invalidating the use restriction information stored in the storage DB and releasing the use restriction for the user A. (4) As a result, the user A can use the information processing apparatus MFP again. According to the above, it is possible to allow the user A to re-use the information processing apparatus MFP after allowing the user A to learn about the virus infection prevention only by the function of the information processing apparatus MFP.

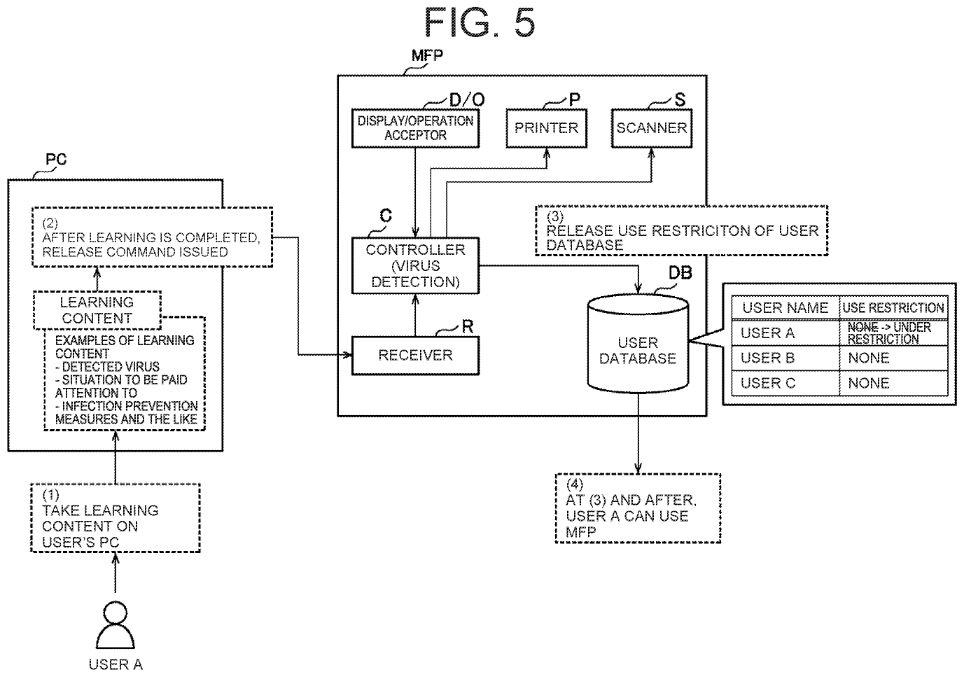

FIG. 5 is a functional block diagram illustrating a third example of the method by which the information processing apparatus MFP according to the Embodiment releases the use restriction. FIG. 5 is a diagram illustrating a mechanism in which the user A, who is the target of the use restriction, performs learning by the learning content by using the personal computer PC of the user A, whereby the use restriction is released.

First, the controller C causes the display of the personal computer PC as a communication terminal to display that it was detected that the job information is infected with a virus. Therefore, the user A can be informed that the job information is infected with a virus.

In this case, the controller C receives the restriction release information from the communication terminal on the basis of a predetermined operation on an operation acceptor of the personal computer PC as a communication terminal capable of communicating with the information processing apparatus MFP. As a result, it is possible to release the restriction on the use by the user A by using the communication terminal outside the information processing apparatus MFP.

Specifically, (1) the user A views an image displayed on the display of the personal computer PC, thereby finishing the learning by the learning content. In this learning, an answer to the learning-effect confirmation test is made by operating the operation acceptor of the personal computer PC. (2) As a result, when the learning-effect confirmation test is passed, the personal computer PC transmits the restriction release information (release command) to the information processing apparatus MFP.

(3) When the controller C of the information processing apparatus MFP receives the release command from the personal computer PC via the receiver R, the controller C rewrites the data “under restriction” in the storage DB to “none”. As a result, the controller C invalidates the use restriction information stored in the storage DB and releases the use restriction of the information processing apparatus MFP by the user A. (4) As a result, the user A can use information processing apparatus MFP again.

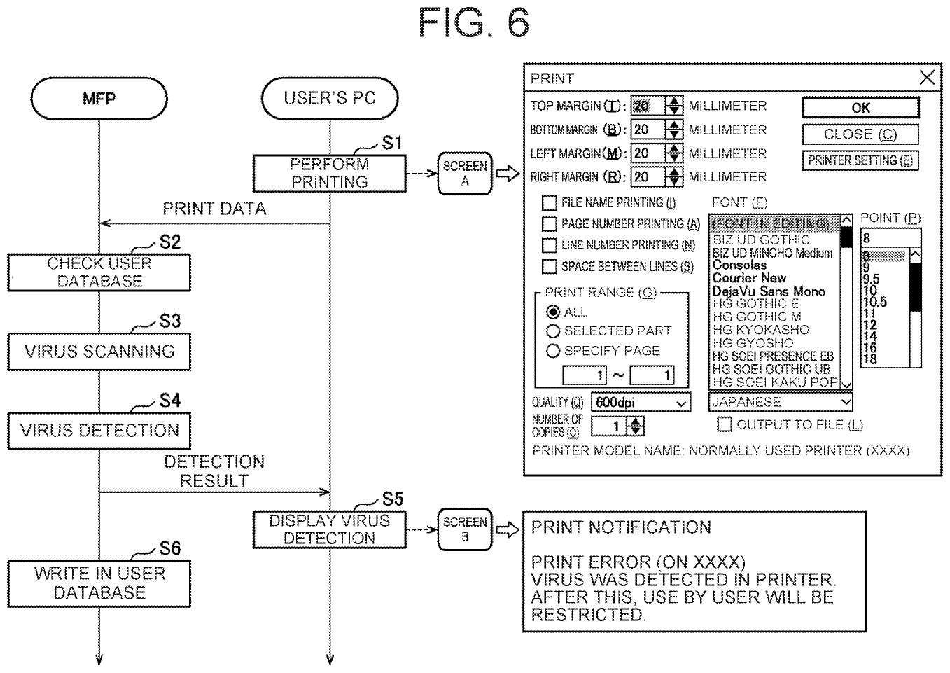

FIG. 6 is a flowchart for explaining a first example of a method of executing the use restriction by the information processing apparatus MFP according to the Embodiment. FIG. 6 is a diagram for explaining processing of executing use restriction of the information processing apparatus MFP for the user A in association with the authentication information of the user A, when a virus was detected due to the operation of the user A.

As shown in FIG. 6, at Step S1, the user performs printing by the printer P of the information processing apparatus MFP in a state where a screen A is displayed on the display of the personal computer PC. Specifically, the user clicks an “OK” button displayed on the screen A. As a result, print data to be printed, that is, job information is transmitted to the information processing apparatus MFP together with the authentication information such as a user name.

At Step S2, the controller C of the information processing apparatus MFP checks the user name stored in the storage DB, that is, the user database. Thereby, it is determined whether or not the user name specified by the authentication information attached to the job information matches the user name of the target of the use restriction of the user name for which the use of the information processing apparatus MFP is restricted.

As a result, if the user name specified by the authentication information attached to the job information does not match the user name of the target of the use restriction, the controller C of the information processing apparatus MFP executes the virus scan at Step S3. Thereby, at Step S4, if a virus is detected, the controller C causes its own transmitter to transmit the detection result to the user's personal computer PC. At Step S5, the user checks the virus detection display transmitted from the information processing apparatus MFP on a screen B of the personal computer PC.

As a result, the user gets to know that the job information transmitted from the personal computer PC to the information processing apparatus MFP by the user himself/herself is infected with a virus. Moreover, at Step S6, the controller C of the information processing apparatus MFP causes the use restriction information to be stored in the storage DB in association with the user name specified by the authentication information accompanied by the job information determined to be infected with the virus.

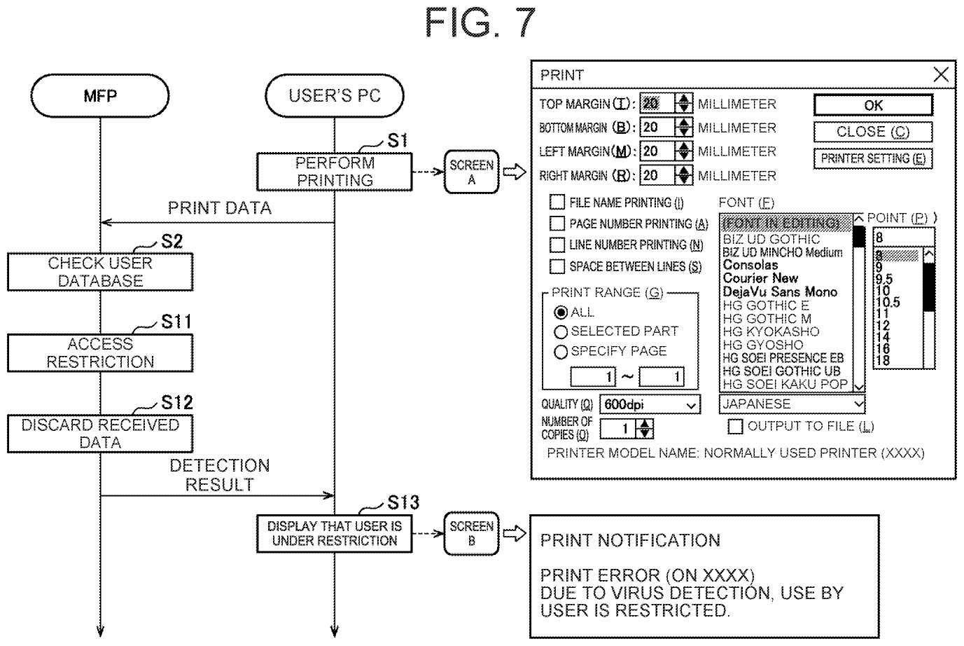

FIG. 7 is a flowchart for explaining the second example of the method of executing use restriction by the information processing apparatus MFP according to the Embodiment. FIG. 7 illustrates an example of processing and a screen display for explaining the use restriction executed when the job information is received from the user A, who is the target of the use restriction. Hereinafter, only parts in FIG. 7 different from those in FIG. 6 above will be explained.

As shown in FIG. 7, at Step S11, the controller C of the information processing apparatus MFP restricts the use of the information processing apparatus MFP by restricting an access by the personal computer PC to the information processing apparatus MFP. In this case, at Step S12, the controller C of the information processing apparatus MFP discards the received data, that is, the job information accompanied by the user information capable of specifying the user A, and transmits the information capable of specifying that the virus has been detected to the personal computer PC of the user A.

Thereafter, at Step S13, the personal computer PC of the user A causes the display to display information capable of specifying that the use of the information processing apparatus MFP by the user A is restricted due to the detection of the virus, as shown in the screen B. As a result, the user A can be informed that the subsequent use of the information processing apparatus MFP is restricted.

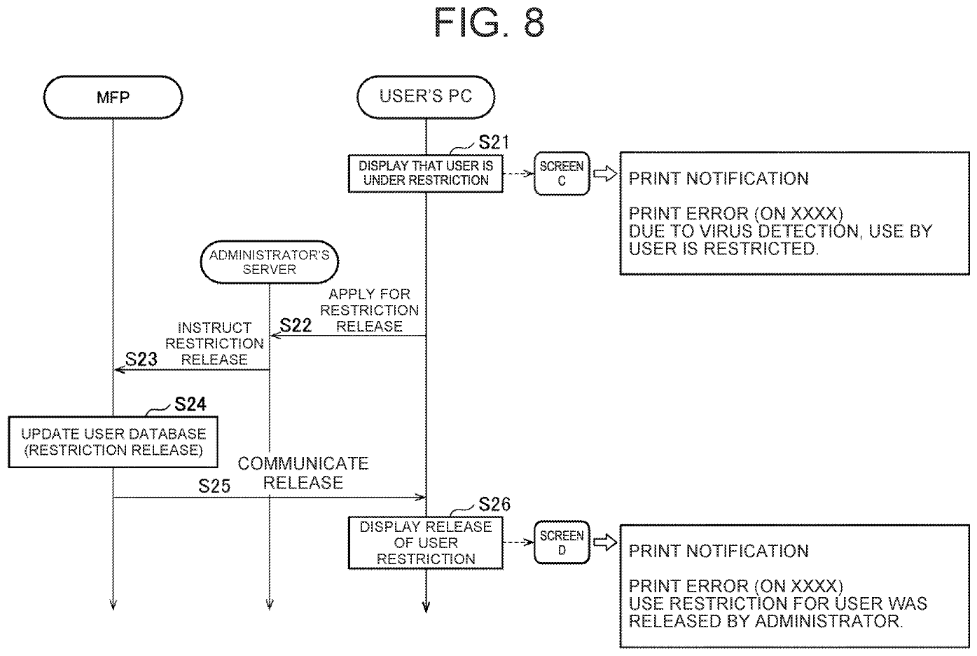

FIG. 8 is a diagram for explaining a first example of a method by which the information processing apparatus MFP according to the Embodiment releases the use restriction. FIG. 8 illustrates an example of processing and a screen display for explaining that the restriction on the use by the user A is released when the user A, who is the target of the use restriction, receives permission from the administrator.

As shown in FIG. 8, at Step S21, a screen C indicating that the use of the information processing apparatus MFP by the user is restricted due to the detection of the virus is displayed on the display of the personal computer PC of the user. The user A viewing the screen C learns the virus infection prevention by the learning content.

Thereafter, at Step S22, the personal computer PC of the user transmits, to the management server CS, restriction release information (application) capable of specifying that the user A has appropriately finished the learning. As a result, the management server CS which has received the restriction release information (application) transmits the restriction release information (instruction) to the information processing apparatus MFP at Step S23.

Thereafter, at Step S24, the controller C of the information processing apparatus MFP releases the use restriction of the information processing apparatus MFP by the user A by invalidating the use restriction information stored in the storage DB. At Step S25, the information processing apparatus MFP transmits the restriction release information (notification) capable of specifying that the use restriction has been released to the personal computer PC of the user. As a result, at Step S26, the display of the personal computer PC displays that the use restriction of the information processing apparatus MFP has been released by the management server CS.

The controller C displays, for example, a screen D of FIG. 8 on the display of the personal computer PC of the user. This also makes it possible to notify the user that the restriction on the use of the information processing apparatus MFP has been released.

In this case, the controller C may cause the display of the personal computer PC to display that the learning related to the virus infection prevention has been finished, together with the restriction release information in the screen D. According to this, it is possible to notify the user that the user has appropriately finished the learning about the virus infection prevention.

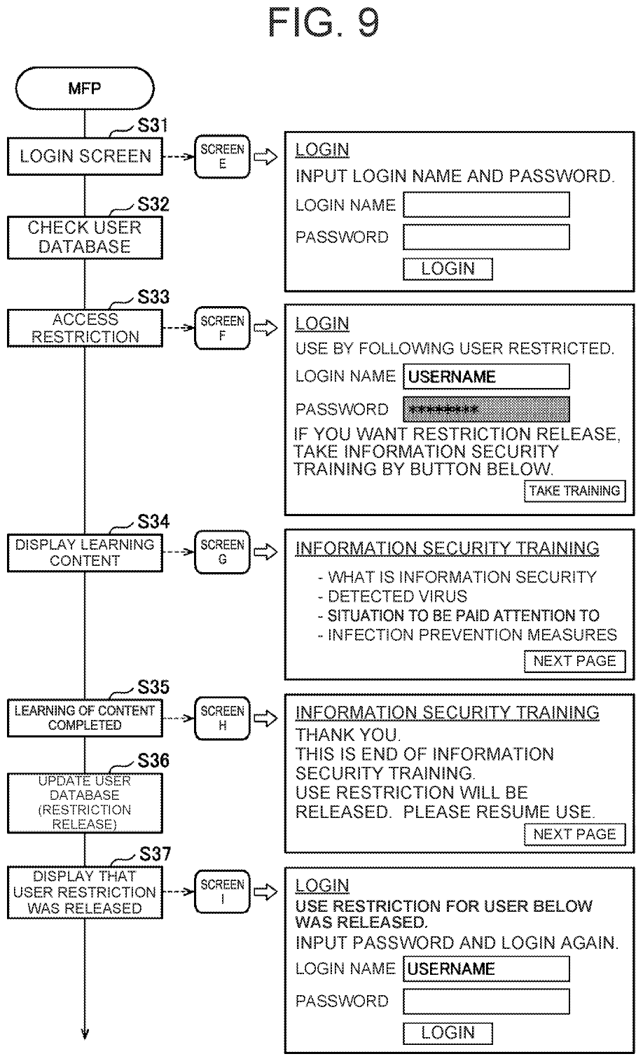

FIG. 9 is a diagram for explaining a second example of the method by which the information processing apparatus MFP according to the Embodiment releases the use restriction. FIG. 9 is a diagram illustrating an example of processing and a screen display for explaining that the restriction on the use by the user is released when the user, who is the target of the use restriction, performs learning by the learning content by using the information processing apparatus MFP.

At Step S31, the controller C of the information processing apparatus MFP causes the display/operation acceptor D/O to display a screen E for login to the display/operation acceptor D/O. At Step S32, when a user name is input by using the screen E for login, the controller C searches the user name stored in the storage DB.

As a result, if the input user name matches the user name of the target of the use restriction stored in the storage DB, the use of the information processing apparatus MFP by the user having the user name is restricted at Step S33. Specifically, the controller C restricts access to the information processing apparatus MFP by the user having the user name. Moreover, the controller C causes the display/operation acceptor D/O to display the use restriction information shown on a screen F in order to notify the user that the use of the information processing apparatus MFP was restricted.

At Step S34, the controller C causes the display/operation acceptor D/O to display a screen G including the learning content. Thereafter, when the learning by using the learning content by the user is appropriately finished, at Step S35, the controller C causes the display/operation acceptor D/O to display a screen H indicating that the learning has been appropriately finished.

Thereafter, at Step S36, the controller C releases the use restriction of the information processing apparatus MFP by the user by invalidating (updating) the use restriction information stored in the storage DB, that is, the database. Thereafter, at Step S37, the controller C causes the display/operation acceptor D/O to display a screen I including the restriction release information capable of specifying that the use restriction has been released. This also makes it possible to notify the user that the information processing apparatus MFP can be used.

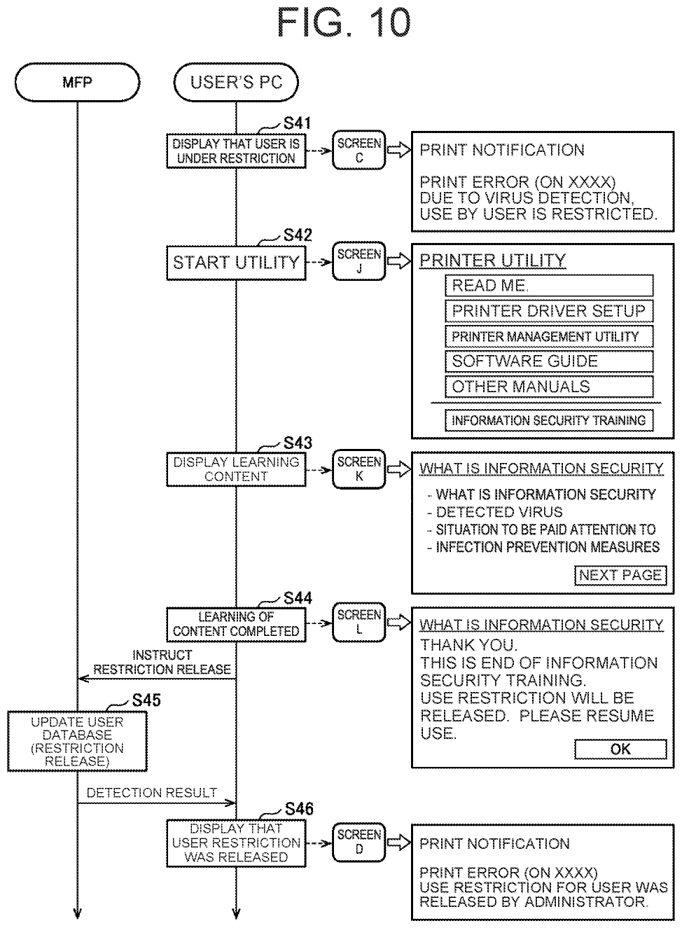

FIG. 10 is a diagram for explaining a third example of the method by which the information processing apparatus MFP according to the Embodiment releases the use restriction. FIG. 10 illustrates an example of processing and a screen display for explaining that the restriction on the use of the information processing apparatus MFP by the user is released when the user, who is the target of the use restriction, performs the learning by the learning content using the personal computer PC.

At Step S41, when the user tries to use the information processing apparatus MFP, since a virus was detected in the user's personal computer PC, the screen C indicating that the use of the information processing apparatus MFP by the user is restricted is displayed. Thereafter, at Step S42, the personal computer PC starts utility and causes the display to display a screen J illustrating the utility.

Subsequently, at Step S43, the personal computer PC causes a screen K including the learning content to be displayed on the display. At Step S44, when the learning using the learning content is appropriately finished, the personal computer PC causes the display to display a screen L indicating that the learning using the learning content has been appropriately finished. Thereafter, the personal computer PC transmits the restriction release information (instruction) to the information processing apparatus MFP.

At Step S45, when the controller C of the information processing apparatus MFP receives the restriction release information (instruction) via the receiver R, the controller C releases the use restriction of the information processing apparatus MFP by the user A by invalidating the use restriction information stored in the storage DB. Thereafter, the controller C causes transmits, to the personal computer PC, restriction release information (detection result) capable of specifying that the use restriction has released to the display/operation acceptor D/O.

As a result, at Step S46, the personal computer PC causes the display to display a screen I indicating that the release of the use restriction can be specified. This also makes it possible to notify the user that the information processing apparatus MFP can be used. In the Embodiment described above, the restriction of the print function was explained as an example of restricting the function of the information processing apparatus MFP. However, the other functions of the information processing apparatus MFP whose use is restricted may be a file saving function (function of storing a file from a user's PC in the storage DB of the information processing apparatus MFP by using FTP “File Transfer Protocol” or SMB “Server Message Block”). Moreover, the other functions of the information processing apparatus MFP whose use is restricted may be Web browser functions (functions of accessing an external Web server from a Web browser incorporated in the information processing apparatus MFP by using Http “Hyper text transfer protocol”).

What is claimed is:

1. An information processing apparatus comprising a controller that, upon reception of job information accompanied by authentication information capable of specifying a user, determines whether the job information is infected with a virus or not, wherein
the controller:
causes use restriction information capable of specifying restriction of use by the user in association with the authentication information to be stored in a storage, when it is determined that the job information is infected with the virus; and
restricts use of the information processing apparatus by the user specified by the authentication information associated with the use restriction information, when the use restriction information is stored in the storage.

2. The information processing apparatus according to claim 1, wherein
the information processing apparatus is a multifunction peripheral that exerts a plurality of functions corresponding to a plurality of apparatuses; and
the controller individually restricts the use of the information processing apparatus by the user for each of the plurality of functions by individually storing the use restriction information in the storage for each of the plurality of functions.

3. The information processing apparatus according to claim 1, wherein
when restriction release information capable of specifying release of the restriction on the use of the information processing apparatus by the user is received, the controller releases the restriction on the use of the information processing apparatus by the user specified by the authentication information by invalidating the use restriction information in the storage.

4. The information processing apparatus according to claim 3, wherein
the controller receives the restriction release information from a management server that manages the information processing apparatus, on the basis of a predetermined operation performed on an operation acceptor of the management server.

5. The information processing apparatus according to claim 3, further comprising an operation acceptor that can be operated by a user, wherein
the controller releases the restriction on the use of the information processing apparatus when a predetermined operation is performed on the operation acceptor.

6. The information processing apparatus according to claim 3, wherein
the controller receives the restriction release information from a communication terminal capable of communicating with the information processing apparatus, on the basis of a predetermined operation performed on an operation acceptor of the communication terminal.

7. A control method of an information processing apparatus including a controller that, upon reception of job information accompanied by authentication information capable of specifying a user, determines whether the job information is infected with a virus or not, wherein
the controller executes:
causing, when the job information is determined to be infected with the virus, use restriction information capable of specifying restriction of use by the user in association with the authentication information to be stored in a storage; and
restricting use of the information processing apparatus by the user specified by the authentication information associated with the use restriction information when the use restriction information is stored in the storage.
